(19) United States
(12) Patent Application Publication
(10) Pub. No.: US 2010/0253072 A1
(43) Pub. Date: Oct. 7, 2010

(54) DETACHABLE PNEUMATIC CONNECTION

(76) Inventor: Guenter Klein, Unterensingen (DE)

Correspondence Address: KENYON & KENYON LLP, ONE BROADWAY, NEW YORK, NY, 10004, US

(21) Appl. No.: 12/664,364

(22) PCT Filed: Jun. 13, 2008
(86) PCT No.: PCT/EP08/04745

§ 371 Date: Apr. 23, 2010

(30) Foreign Application Priority Data
Jun. 13, 2007 (DE) 10 2007 027 148.6

(51) Int. Cl. F16L 33/00

(52) U.S. Cl. 285/255

(57) ABSTRACT

A detachable pneumatic pipe or hose connection includes: a) a compressed-air-carrying body with an accommodating bore for a compressed air hose or pipe, the accommodating bore having a radially inner wedge section, b) an at least partially radially elastic clamping collet which surrounds the hose or pipe and which has a radially outer wedge section, c) the radially outer wedge section of the clamping collet interacting with the radially inner wedge section of the accommodating bore so that, by an axial movement of the clamping collet in one direction, the wedge sections can be braced against one another, and the clamping collet is elastically deformed, at least partially, radially inward to clamp the pipe or the hose frictionally and/or positively and so that, by an axial movement of the clamping collet in the opposite direction, the wedge sections can be moved away from one another, and the clamping collet is elastically deformed radially outward to cancel the clamping of the pipe or hose in the accommodating bore, in which d) the radially inner wedge section is molded directly to a wall of the accommodating bore and is constructed in one piece therewith.

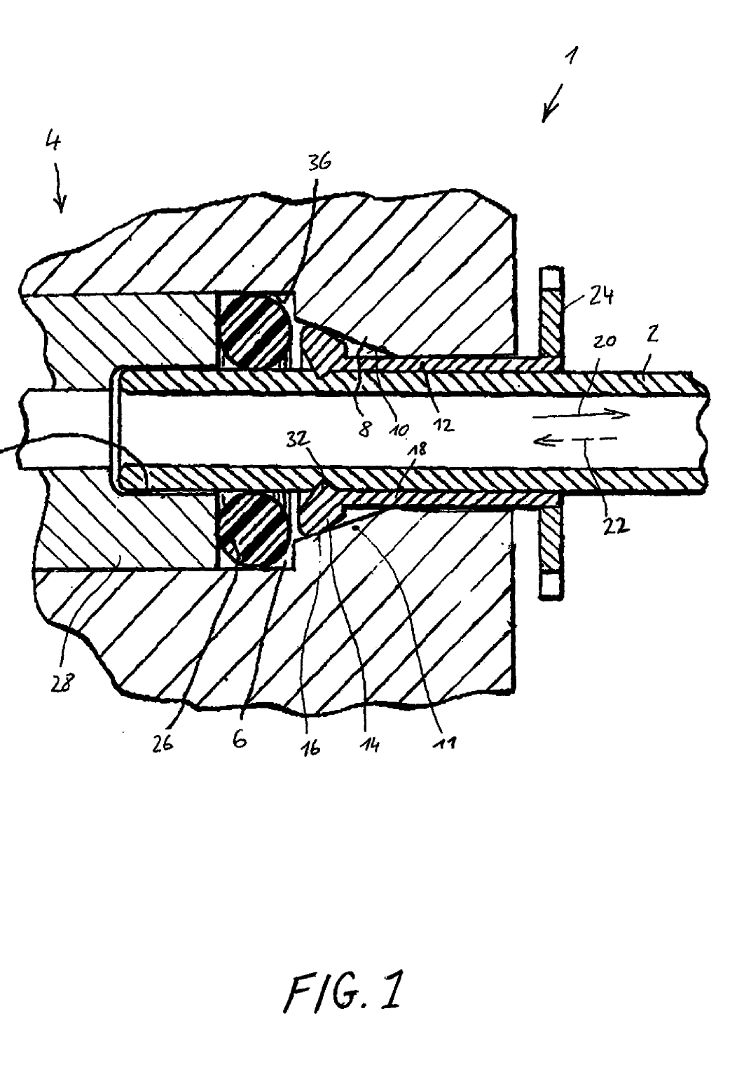

### FIELD OF THE INVENTION

The present invention relates to a detachable pneumatic pipe or hose connection.

### BACKGROUND INFORMATION

A detachable pneumatic pipe or hose connection may include “push-to-connect” connections, in which a pipe or a hose is inserted into an accommodating bore and is clamped frictionally and/or positively by axial movement of the clamping collet held in the accommodating bore, are known from the prior art. A connection of the type in question is discussed in U.S. Pat. No. 4,685,706, for example. Here, the radially inner wedge section is formed on a separate component in the form of a sleeve, which is generally screwed or pressed into the accommodating bore.

Given the foregoing, it is an underlying object of the exemplary embodiment and/or exemplary method of the present invention to develop a detachable pneumatic connection of the type mentioned at the outset in such a way that it is simpler and less costly to manufacture.

### SUMMARY OF THE INVENTION

According to the exemplary embodiment and/or exemplary method of the present invention, this object may be achieved by the features described herein.

The exemplary embodiment and/or exemplary method of the present invention is based on the concept of molding the radially inner wedge section directly to a wall of the accommodating bore and constructing it in one piece therewith. The separate component on which the inner wedge section is formed in the prior art can then be omitted, as can the manufacturing step of screwing this component to the accommodating bore or pressing it into the latter. Because there is then also no longer any need to take account of space for the application of a screwing tool for this separate component, pneumatic connections according to the invention can be positioned closer to one another axially, resulting in a more compact shape.

The clamping collet advantageously fulfils a dual function, on the one hand guiding the pipe or hose with its radially inner circumferential surface when the hose or the pipe is moved axially and, on the other hand, clamping the hose or the pipe as a function of its axial position relative to the accommodating bore or the radially inner wedge section thereof.

Advantageous developments and improvements of the invention disclosed in the independent claims are possible by virtue of the measures presented in the subclaims.

In an exemplary embodiment, the clamping collet is slotted, when viewed in an axial direction, in order to produce the radial elasticity.

According to a development, the body provided with the accommodating bore can be formed by a compressed-air device, e.g. by a pressure control module for building up, holding or reducing a brake pressure in an electropneumatic brake system of a motor vehicle. The hose or the pipe is then used for supply to or discharge from the pressure control module.

In an exemplary embodiment, at least one sealing ring is also provided between a radially inner circumferential surface of the accommodating bore and a radially outer circumferential surface of the pipe or of the hose, said sealing ring lying opposite an end face of the clamping collet. This sealing ring ensures pressuretight sealing of the interior of the accommodating bore with respect to the surroundings.

If, on a section projecting from the accommodating bore, the clamping collet has a collar which extends radially outward, then it can be moved easily in an axial direction by engagement on the collar in order to make or undo the pneumatic connection.

An exemplary embodiment of the invention is illustrated in the drawing and explained in greater detail in the description which follows.

### BRIEF DESCRIPTION OF THE DRAWINGS

The FIGURE shows a cross section through a detachable pneumatic connection in accordance with an exemplary embodiment of the present invention.

### DETAILED DESCRIPTION

A detachable pneumatic pipe or hose connection, as described herein, first includes:
a) a compressed-air-carrying body with an accommodating bore for a compressed air hose or a compressed air pipe, the accommodating bore having a radially inner wedge section, and
b) an at least partially radially elastic clamping collet which surrounds the hose or the pipe and which has a radially outer wedge section,
c) wherein the radially outer wedge section of the clamping collet interacts with the radially inner wedge section of the accommodating bore in such a manner that, by an axial movement of the clamping collet in one direction, the wedge sections can be braced against one another, and the clamping collet is thereby elastically deformed radially inward in order to clamp the pipe or the hose frictionally and/or positively and in such a manner that, by an axial movement of the clamping collet in the opposite direction, the wedge sections can be moved away from one another, and the clamping collet is thereby elastically deformed radially outward again in order to cancel the clamping of the pipe or of the hose in the accommodating bore.

An exemplary embodiment of a detachable pneumatic connection 1 between a pipe or hose 2, which is, for example, flexible, and a compressed-air device 4, e.g. a pressure control module of an electropneumatic brake system, is illustrated in the FIGURE. The compressed-air device 4 has an accommodating bore 6 for the pipe 2, which bore has a radially inner wedge section 8. This radially inner wedge section 8, and in particular a wedge surface 10 of this wedge section 8, is molded directly to a wall 11 of the accommodating bore 6 and is constructed in one piece therewith.

Moreover, there is an at least partially radially elastic clamping collet 12 which surrounds the hose or the pipe 2 and which has a radially outer wedge section 14 with a corresponding wedge surface 16. In an exemplary embodiment, the clamping collet 12 is slotted when viewed in an axial direction, i.e. freely projecting clamping fingers 18 extending in an axial direction are formed in order to produce a radial elasticity. As a departure from the radially inner wedge section 8, the accommodating bore 6 is of smooth cylindrical design at the end, with a diameter that allows linear guidance of the clamping collet 12 in an axial direction.

The radially outer wedge section 14 of the clamping collet 12 interacts with the radially inner wedge section 8 of the accommodating bore 6 in such a manner that, by an axial movement of the clamping collet 12 in a direction indicated by an arrow 20 drawn with a solid line, the wedge sections 8, 14 are braced against one another, and the clamping collet and, in particular, the clamping fingers 18 thereof are thereby elastically deformed radially inward in order to clamp the pipe or the hose 2 frictionally and/or positively and in such a manner that, by an axial movement of the clamping collet 12 in an opposite direction, indicated by an arrow 22 drawn with a broken line, the wedge sections 8, 14 are moved away or disengaged from one another, and the clamping collet 12 and, in particular, the clamping fingers 18 thereof are thereby elastically deformed radially outward again in order to cancel the clamping of the pipe or of the hose 2 in the accommodating bore 6.

On a section projecting from the accommodating bore 6, the clamping collet 12 may have a collar 24 which extends radially outward. This collar 24 is a separate component and may be screwed onto the free end of the clamping collet 12. The clamping collet 12 can then be moved easily in an axial direction by applying a tool or a hand to the collar 24 in order to make or undo the pneumatic connection 1. An axial stop for the clamping collet 12 is then formed by the two mutually contacting wedge sections 8, 14 when the pneumatic connection 1 is made.

In an exemplary embodiment, at least one sealing ring 26 is also provided between a radially inner circumferential surface of the accommodating bore 6 and a radially outer circumferential surface of the pipe or of the hose 2, said sealing ring lying opposite an end face of the clamping collet 12. This sealing ring 26 ensures pressuretight sealing of the interior of the accommodating bore 6 with respect to the surroundings. On one side, the sealing ring 26 is secured against a sleeve 28, which is inserted into a smooth cylindrical section 36 of the accommodating bore 6, by a screwed joint for example. At its end pointing toward the pipe or hose 2, this sleeve 28 has a radially inner annular recess 30, the end face of which forms a stop for the pipe or the hose 2. This sealing ring 26 simultaneously forms the other axial stop for one end position of the clamping collet 12 when the pneumatic connection 1 is undone.

Not least among the various features is that, in the region of the clamping fingers 18, the clamping collet 12 may have at least one projection 32 projecting radially inward, which may be in the form of one or more cutting edges 34 to ensure that, during the radially inward movement of the clamping fingers 18 caused by the axial movement of the clamping collet 12 and the mutual bracing of the wedge sections 8, 14 which then occurs, not only frictional engagement between the clamping fingers 18 and the pipe or hose 2 but also a positive engagement is produced in addition when the cutting edge 34 penetrates the flexible plastic material of the pipe or of the hose 2. The elasticity-induced bracing of the wedge sections 8, 14 against one another and the resulting static friction hold the clamping collet 12 in its axial position.

To produce the pneumatic connection 1, the accommodating bore 6 for the pipe or the hose 2 in the compressed-air device 4 and, in particular, the radially inner wedge section 8 is first of all produced, by machining for example. The section 36 of the accommodating bore 6 which deviates from the wedge section 8 may be of smooth cylindrical design.

The clamping collet 12 is then inserted from the inside of the compressed-air device 4, and the collar 24 is screwed onto its end projecting outward from the accommodating bore 6. The sealing ring 26, which may be in the form of an O ring, is then inserted into the smooth cylindrical section 36 of the accommodating bore 6, followed by the sleeve 28.

As a departure from the embodiment described, additional sealing rings or dirt scraper rings can be provided. Defined passages could furthermore be formed in the accommodating bore 6, in the clamping collet 12 or in the sealing or dirt scraper rings 26 in such a manner as to give rise to an air flow that produces an audible sound which indicates leaks. Moreover, multiple clamping involving a plurality of wedge sections 8, 14 arranged axially in series is also conceivable, frictional engagement or positive engagement between the clamping collet 12 and the pipe or hose 2 being produced at each wedge section 8, 14. It is likewise conceivable to arrange the sealing ring or rings 26 behind the clamping collet 12 instead of in front of it, when viewed from an interior space of the compressed-air device 4. A discernible feedback as regards correct pneumatic connection 1 between the pipe or hose 2 and the compressed-air device 4 could furthermore be accomplished through releasable latching of the clamping collet 12 in the accommodating bore 6.

Not least among the various features is that the pneumatic connection 1 according to the invention can also be formed between two pipes or hoses 2 if there is an appropriate accommodating bore 6 with a clamping collet 12 at one end of the pipe or hose 2, in the form of an adaptor for example.

The List of reference numerals is as follows:
1 Connection
2 Pipe
4 Compressed-air device
6 Accommodating bore
8 Wedge section
10 Wedge surface
11 Wall of bore
12 Clamping collet
14 Wedge section
16 Wedge surface
18 Clamping finger
20 Arrow
22 Arrow
24 Collar
26 Sealing ring
28 Sleeve
30 Recess
32 Projection
34 Cutting edge
36 Section

1-10. (canceled)

11. A detachable pneumatic pipe or hose connection, comprising:
a compressed-air-carrying body with an accommodating bore for a compressed air hose or a compressed air pipe, the accommodating bore having a radially inner wedge section; and
an at least partially radially elastic clamping collet which surrounds the pipe or the hose, and which has a radially outer wedge section;
wherein the radially outer wedge section of the clamping collet interacts with the radially inner wedge section of the accommodating bore so that, by an axial movement of the clamping collet in one direction, the wedge sections can be braced against one another, and the clamping collet is thereby elastically deformed, at least partially, radially inward to clamp the pipe or the hose at least one of frictionally and positively and so that, by an axial movement of the clamping collet in opposite direction, the wedge sections can be moved away from one another, and the clamping collet is elastically deformed radially outward again to cancel the clamping of the pipe or of the hose in the accommodating bore, and
wherein the radially inner wedge section is molded directly to a wall of the accommodating bore and is constructed in one piece therewith.

12. The detachable pneumatic pipe or hose connection of claim 11, wherein the clamping collet is slotted when viewed in an axial direction.

13. The detachable pneumatic pipe or hose connection of claim 12, wherein the clamping collet has freely projecting clamping fingers extending in an axial direction.

14. The detachable pneumatic pipe or hose connection of claim 11, wherein the compressed-air-carrying body provided with the accommodating bore formed by a compressed-air device.

15. The detachable pneumatic pipe or hose connection of claim 11, wherein at least one sealing ring is provided between a radially inner circumferential surface of the accommodating bore and a radially outer circumferential surface of the pipe or of the hose, the sealing ring lying opposite an end face of the clamping collet.

16. The detachable pneumatic pipe or hose connection of claim 15, wherein the sealing ring is secured by a sleeve, which is inserted into the accommodating bore.

17. The detachable pneumatic pipe or hose connection of claim 11, wherein, on a section projecting from the accommodating bore, the clamping collet has a collar which extends radially outward.

18. The detachable pneumatic pipe or hose connection of claim 17, wherein the collar (24) is detachably connected to the clamping collet (12).

19. The detachable pneumatic pipe or hose connection of claim 11, wherein releasable latching is provided between the clamping collet and the wall of the accommodating bore.

20. The detachable pneumatic pipe or hose connection of claim 11, wherein defined passages are formed at least one of in the accommodating bore and in the clamping collet or in the sealing ring so as to give rise to an air flow that produces an audible sound which indicates a leak.
